(19) United States
(12) Patent Application Publication
(10) Pub. No.: US 2026/0315172 A1
(43) Pub. Date: Oct. 15, 2026

(54) ULTRASOUND DIAGNOSTIC DEVICE SUPPORT APPARATUS AND ULTRASOUND DIAGNOSTIC APPARATUS

(71) Applicant: FUJIFILM Corporation, Tokyo (JP)

(72) Inventor: Keno MURAKAMI, Tokyo (JP)

(73) Assignee: FUJIFILM Corporation, Tokyo (JP)

(21) Appl. No.: 19/463,028

(22) Filed: Jan. 28, 2026

(30) Foreign Application Priority Data
Feb. 4, 2025 (JP) 2025-016564

(51) Int. Cl. A61B 50/13

(52) U.S. Cl. CPC A61B 50/13

(57) ABSTRACT

A cart includes a support structure that allows an ultrasound diagnostic device to be attached to and detached from the support structure. The support structure is composed of a support, a support column, and a table. The cart includes a connection mechanism, an operation mechanism, and an engagement mechanism. The connection mechanism electrically connects the ultrasound diagnostic device and a hard disk drive attached to the support structure in a case where the ultrasound diagnostic device is coupled to the support structure. The operation mechanism releases the coupling between the ultrasound diagnostic device and the connection mechanism in response to an operation of a user. The engagement mechanism is in an engaged state or a released state with respect to the ultrasound diagnostic device depending on whether or not the connection mechanism electrically connects the ultrasound diagnostic device and the hard disk drive.

### CROSS-REFERENCE TO RELATED APPLICATION

This application claims the priority benefit of Japan application serial no. 2025-016564, filed on Feb. 4, 2025. The entirety of the above-mentioned patent application is hereby incorporated by reference herein and made a part of this specification.

### BACKGROUND OF THE INVENTION

### 1. Field of the Invention

The present disclosure relates to an ultrasound diagnostic device support apparatus and an ultrasound diagnostic apparatus, and particularly to an apparatus that supports an ultrasound diagnostic device and an electronic device external to the ultrasound diagnostic device.

### 2. Description of the Related Art

An ultrasound diagnostic apparatus that observes a tissue of a subject by transmitting and receiving ultrasonic waves is widely used. An ultrasound diagnostic apparatus comprises an ultrasound diagnostic device (main body apparatus) and a cart, and the ultrasound diagnostic device is attachable to and detachable from the cart. The cart is a device that supports the ultrasound diagnostic device on casters, and the ultrasound diagnostic device is mounted on the cart, so that diagnosis and transport of the ultrasound diagnostic device are facilitated.

There are carts on which electronic devices such as external storage media are mounted. In this case, in a case where the ultrasound diagnostic device is attached to the cart, the ultrasound diagnostic device is connected to the electronic device. In a case where the ultrasound diagnostic device is detached from the cart, the ultrasound diagnostic device is also disconnected from the electronic device.

In WO2013/129034A, in a portable ultrasound diagnostic apparatus, processing inside the portable ultrasound diagnostic apparatus is controlled in response to opening and closing of a lid housing in which a monitor is disposed. It is described that processing executed inside the apparatus is appropriately ended in a case where the lid housing is closed. In WO2013/118383A, in a portable ultrasound diagnostic apparatus, in a case where power supply from a battery may not be possible, a high-speed storage medium that performs storage processing at a speed faster than a normal speed executes storage processing on data being transmitted.

### SUMMARY OF THE INVENTION

In a case where the ultrasound diagnostic apparatus is in operation and the ultrasound diagnostic device is detached from the cart, the ultrasound diagnostic device is disconnected from the external electronic device, and data transmitted between the ultrasound diagnostic device and the external electronic device may be lost.

An object of the present disclosure is to avoid loss of data due to disconnection of the ultrasound diagnostic device from the electronic device.

An ultrasound diagnostic device according to an aspect of the present disclosure comprises a support structure that allows an ultrasound diagnostic device to be attached to and detached from the support structure, a connection mechanism that is provided in the support structure and that electrically connects the ultrasound diagnostic device and an electronic device attached to the support structure, in a case where the ultrasound diagnostic device is coupled to the connection mechanism, an operation mechanism that releases the coupling between the ultrasound diagnostic device and the connection mechanism in response to an operation of a user, and an engagement mechanism that is in an engaged state in a case where the connection mechanism electrically connects the ultrasound diagnostic device and the electronic device, thereby engaging the support structure with the ultrasound diagnostic device, and that is in a released state in a case where the connection mechanism does not electrically connect the ultrasound diagnostic device and the electronic device, thereby releasing the ultrasound diagnostic device from the support structure.

In one embodiment, the ultrasound diagnostic device further comprises a controller that is provided in the connection mechanism, in which the controller determines whether or not the connection mechanism electrically connects the electronic device and the ultrasound diagnostic device, sets the engagement mechanism to the engaged state in a case where it is determined that the connection mechanism electrically connects the ultrasound diagnostic device and the electronic device, and sets the engagement mechanism to the released state in a case where it is determined that the connection mechanism does not electrically connect the ultrasound diagnostic device and the electronic device.

In one embodiment, the ultrasound diagnostic device further comprises a drive mechanism that drives the engagement mechanism by electric power, in which the drive mechanism sets the engagement mechanism to the engaged state, depending on a state of power supply to the drive mechanism, in a case where the connection mechanism electrically connects the ultrasound diagnostic device and the electronic device, and the drive mechanism sets the engagement mechanism to the released state, depending on the state of power supply to the drive mechanism, in a case where the connection mechanism does not electrically connect the ultrasound diagnostic device and the electronic device.

In one embodiment, the drive mechanism includes a drive shaft, and a power drive mechanism that pulls out a part of the drive shaft depending on the state of power supply and that accommodates the part of the drive shaft depending on the state of power supply, and the engagement mechanism further engages with the ultrasound diagnostic device by pulling out the part of the drive shaft from the drive mechanism and releases the engagement with the ultrasound diagnostic device by accommodating the part of the drive shaft in the drive mechanism.

In one embodiment, the connection mechanism includes a connector, and the operation mechanism attaches the connector to the ultrasound diagnostic device or detaches the connector from the ultrasound diagnostic device in response to the operation of the user.

In one embodiment, the electronic device is a storage medium.

An ultrasound diagnostic apparatus according to an aspect of the present disclosure comprises the ultrasound diagnostic device support apparatus and the ultrasound diagnostic device.

According to the present disclosure, it is possible to avoid loss of data due to the ultrasound diagnostic device being disconnected from the electronic device.

### BRIEF DESCRIPTION OF THE DRAWINGS

FIG. 1 is a perspective view of an ultrasound diagnostic apparatus as viewed from a rear oblique upward direction.

FIG. 2 is a perspective view of a table in a state where an ultrasound diagnostic device is detached as viewed from a front oblique upward direction.

FIG. 3 is a diagram showing a positional relationship between each component of the ultrasound diagnostic apparatus.

FIG. 4 is a diagram showing a positional relationship between each component of the ultrasound diagnostic apparatus.

FIG. 5 is a diagram showing a positional relationship between each component of the ultrasound diagnostic apparatus.

FIG. 6 is a diagram schematically showing the ultrasound diagnostic device, a catching mechanism, a drive mechanism, and a connection mechanism in a case where an operation lever is in a non-restrained state.

FIG. 7 is a diagram schematically showing the ultrasound diagnostic device, the catching mechanism, the drive mechanism, and the connection mechanism in a case where the operation lever is in a restrained state.

### DESCRIPTION OF THE PREFERRED EMBODIMENTS

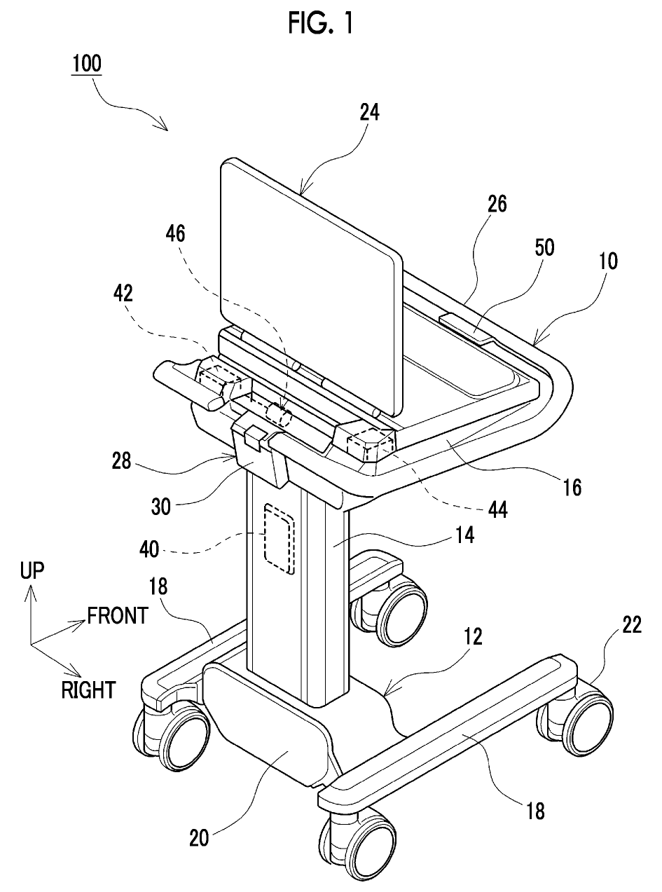

An embodiment of the present disclosure will be described with reference to the drawings. The same components shown in a plurality of drawings are denoted by the same reference numerals to simplify the description thereof. FIG. 1 is a perspective view of an ultrasound diagnostic apparatus 100 according to the embodiment of the present disclosure as viewed from a rear oblique upward direction.

The ultrasound diagnostic apparatus 100 comprises a cart 10 and an ultrasound diagnostic device 24. The cart 10 is an ultrasound diagnostic device support apparatus that supports the ultrasound diagnostic device 24 and facilitates diagnosis using the ultrasound diagnostic device 24 and transport of the ultrasound diagnostic device 24. An ultrasound probe is connected to the ultrasound diagnostic device 24, and the ultrasound diagnostic device 24 transmits ultrasonic waves from the ultrasound probe to a subject. The ultrasound diagnostic device 24 generates image data indicating an inside of the subject based on reflected ultrasonic waves that are reflected by the subject and received by the ultrasound probe.

The cart 10 has a support structure composed of a support 12, a support column 14, and a table 16. The support 12 is composed of two front-rear direction frames 18 that are aligned in a direction extending in a front-rear direction, a lateral direction frame 20 that bridges between the two front-rear direction frames 18, and four casters 22. The caster 22 is attached to each of a front end part and a rear end part of the two front-rear direction frames 18.

A lower end of the support column 14 is fixed to a central portion of the lateral direction frame 20. The support column 14 extends upward from a portion fixed to the lateral direction frame 20. The table 16 is fixed to an upper end of the support column 14. An upper surface of the table 16 extends in a direction along a floor, and FIG. 1 shows a state where the ultrasound diagnostic device 24 is placed on the table 16. A handle 26 that surrounds the table 16 in a C-shape with a rear side released is attached to the table 16. A section of the handle 26 extending in a lateral direction in front of the handle 26 is coupled to a front side of the table 16 by a fixing block 50. The cart 10 is movable along a floor of a room in which the ultrasound diagnostic apparatus 100 is used by the caster 22 attached to each of the front end part and the rear end part of the two front-rear direction frames 18. The user may move the cart 10 by gripping the handle 26.

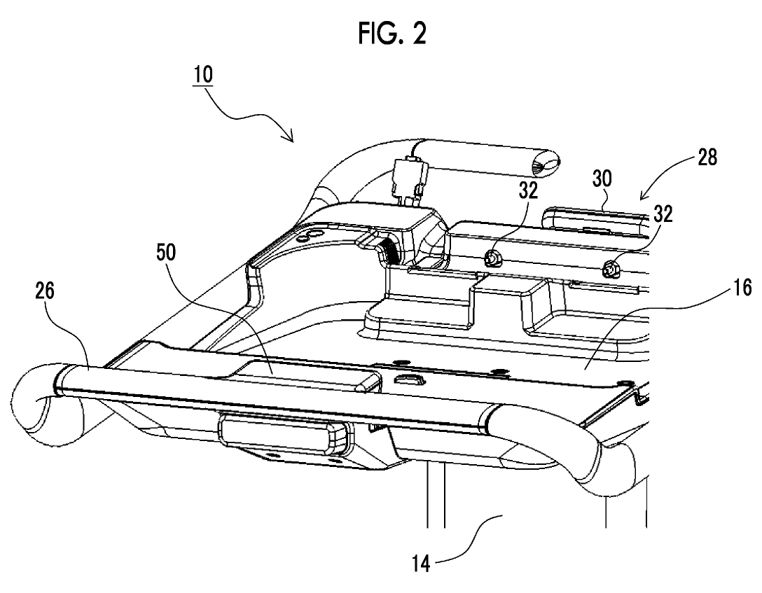

An operation mechanism 28 that restricts the ultrasound diagnostic device 24 to the table 16 is provided behind the table 16. FIG. 2 is a perspective view of the table 16 in a state where the ultrasound diagnostic device 24 is detached as viewed from a front oblique upward direction. The operation mechanism 28 comprises an operation lever 30, a rotational movement shaft, and two restriction pins 32. The operation lever 30 is a member having a substantially rectangular shape as viewed from the rear side. A lower portion of the operation lever 30 is attached to the rotational movement shaft extending in a left-right direction. The operation lever 30 is rotated about the rotational movement shaft to be in any of a non-restrained state in which an upper portion thereof is separated from the table 16 or a restrained state in which the upper portion thereof is close to the table 16.

In a case where the ultrasound diagnostic device 24 is mounted on the table 16, the operation lever 30 is set to the non-restrained state, and the ultrasound diagnostic device 24 is placed on the upper surface of the table 16. Thereafter, the operation lever 30 is operated, and the operation lever 30 is set to the restrained state from the non-restrained state. In a case where the operation lever 30 is in the restrained state, the two restriction pins 32 protrude forward from a rear portion of the table 16, and the two restriction pins 32 are inserted into two holes provided on a rear surface of the ultrasound diagnostic device 24. As a result, a rear portion of the ultrasound diagnostic device 24 is restricted to the table 16.

Returning to FIG. 1, description will be provided. In FIG. 1, components that are not visible among the components mounted on the cart 10 are shown by a broken line. A hard disk drive 40 is attached to the support column 14 of the cart 10 as electronic device external to the ultrasound diagnostic device 24. The hard disk drive 40 may be attached inside the support column 14 or may be attached to a side surface of the support column 14. A catching mechanism 42 is provided on a rear left side of the table 16, and a connection mechanism 44 is provided on a rear right side of the table 16. As the electronic device such as the storage medium attached to the cart 10, a semiconductor memory may be used instead of the hard disk drive 40 or together with the hard disk drive 40. A drive mechanism 46 is attached to a rear center portion of the table 16.

In addition, the electronic device may be an information processing apparatus that performs predetermined image processing on data transmitted from the ultrasound diagnostic device 24 and returns the data to the ultrasound diagnostic device 24. In addition, the electronic device may be an information processing apparatus that provides a database for the operation of the ultrasound diagnostic device 24.

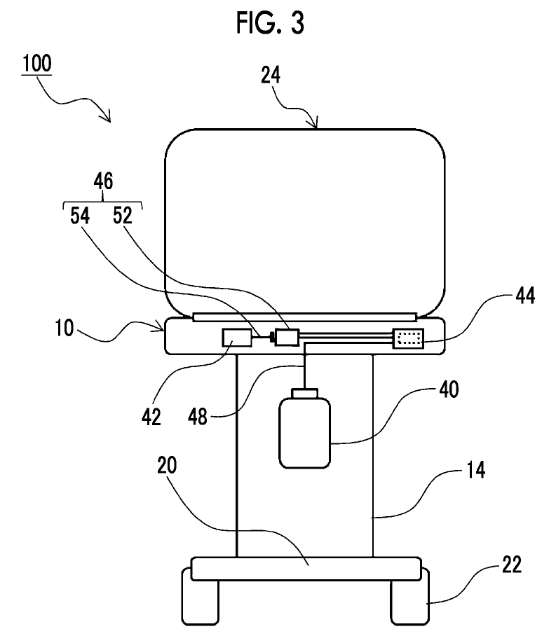

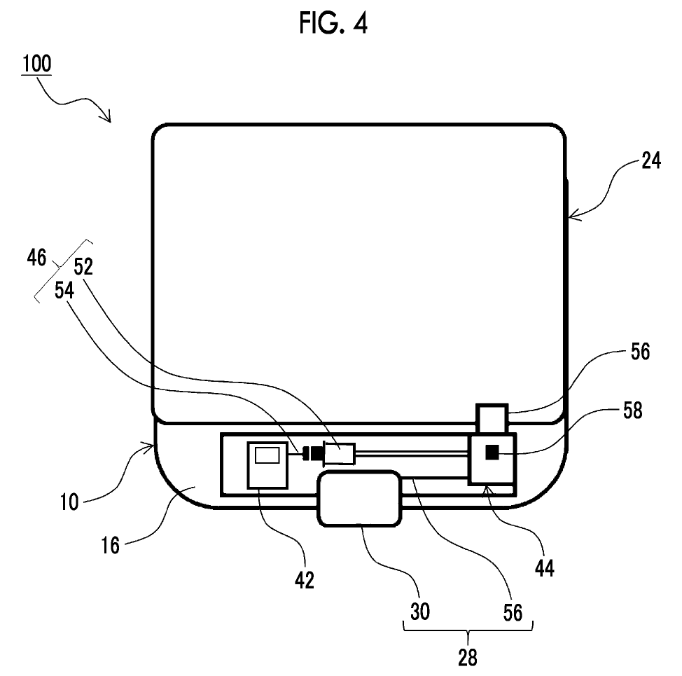

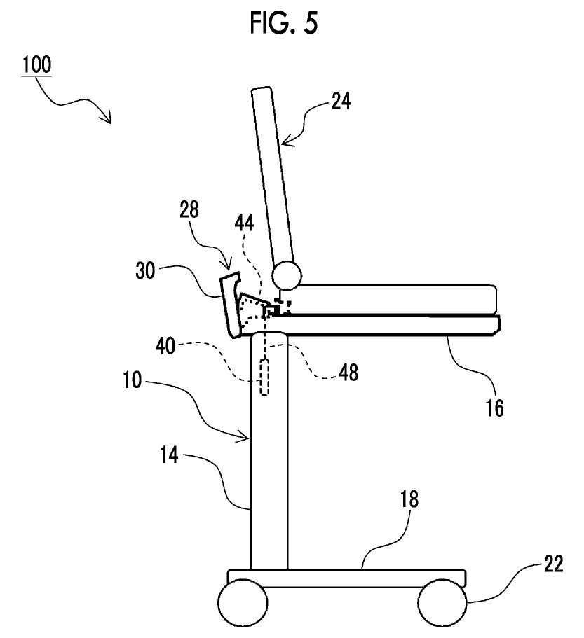

FIG. 3 schematically shows a positional relationship between the hard disk drive 40, the catching mechanism 42, the connection mechanism 44, and the drive mechanism 46 in the cart 10 in a case where the ultrasound diagnostic apparatus 100 is viewed from the rear side. FIG. 4 schematically shows a positional relationship between the catching mechanism 42, the operation mechanism 28, the connection mechanism 44, and the drive mechanism 46 in the cart 10 in a case where the ultrasound diagnostic apparatus 100 is viewed from above. FIG. 5 schematically shows a positional relationship between the hard disk drive 40, the operation mechanism 28, and the connection mechanism 44 in the cart 10 in a case where the ultrasound diagnostic apparatus 100 is viewed from the right side. FIGS. 3-5 show the positional relationship between the components, and do not necessarily show exact structures.

As shown in FIG. 4, the connection mechanism 44 comprises a connector 56. The connection mechanism 44 electrically connects the ultrasound diagnostic device 24 and the hard disk drive 40 in a case where the ultrasound diagnostic device 24 is coupled via the connector 56.

In a case where the operation lever 30 of the operation mechanism 28 is in the restrained state in a state where the ultrasound diagnostic device 24 is placed on the table 16, the connector 56 is attached to the ultrasound diagnostic device 24. In addition, in a case where the operation lever 30 is in the non-restrained state, the connector 56 is detached from the ultrasound diagnostic device 24, and the coupling between the ultrasound diagnostic device 24 and the connection mechanism 44 is released. The connector 56 is connected to the hard disk drive 40 by a cable 48. In a case where the operation lever 30 is in the restrained state, the ultrasound diagnostic device 24 is electrically connected to the hard disk drive 40 via the connector 56 and the cable 48. In a case where the operation lever 30 is in the non-restrained state, the ultrasound diagnostic device 24 and the hard disk drive 40 are disconnected from each other.

The drive mechanism 46 comprises a solenoid 52 and a drive shaft 54. The solenoid 52 operates by electric power. That is, the solenoid 52 is a power drive mechanism that pulls out a part of the drive shaft 54 depending on a state of power supply and that accommodates the part of the drive shaft 54 depending on the state of power supply.

The solenoid 52 according to the present embodiment is formed in a tubular shape, and in a state where power is supplied, a part of the drive shaft 54 accommodated in the solenoid 52 is pulled out from the solenoid 52, and the drive shaft 54 is in a pulled-out state. In a case where the power is not supplied to the solenoid 52, a part of the drive shaft 54 is accommodated inside the solenoid 52, and the drive shaft 54 is in an accommodated state.

A distal end of the drive shaft 54 is coupled to the catching mechanism 42. The solenoid 52 drives the catching mechanism 42 by electric power via the drive shaft 54. In a case where the drive shaft 54 is in the pulled-out state, the catching mechanism 42 is in a caught state in which the ultrasound diagnostic device 24 is caught, and the ultrasound diagnostic device 24 is in a state where it is not detached from the table 16. In a case where the drive shaft 54 is in the accommodated state, the catching mechanism 42 is in a released state in which the catching with the ultrasound diagnostic device 24 is released, and the ultrasound diagnostic device 24 is in a state where it is detachable from the table 16. As described above, the catching mechanism 42 has a function as an engagement mechanism that engages with the ultrasound diagnostic device 24 or releases the engagement with the ultrasound diagnostic device 24 (engaged state with the ultrasound diagnostic device 24) in response to the state of the drive shaft 54. Here, the engagement refers to a state in which two mechanisms are mechanically coupled to each other by a mechanical action from one of the two mechanisms to the other or by a mechanical action between the two mechanisms. The catching is one aspect of the engagement.

In a case where the drive mechanism 46 is in the released state, in a state where the ultrasound diagnostic device 24 is restricted to the table 16 by the restriction pin 32 shown in FIG. 2, the ultrasound diagnostic device 24 is in a state where it is stably placed on the table 16, but is detachable from the table 16. However, the ultrasound diagnostic device 24 is prevented from falling off from the table 16 due to the shaking or inclination of the cart 10.

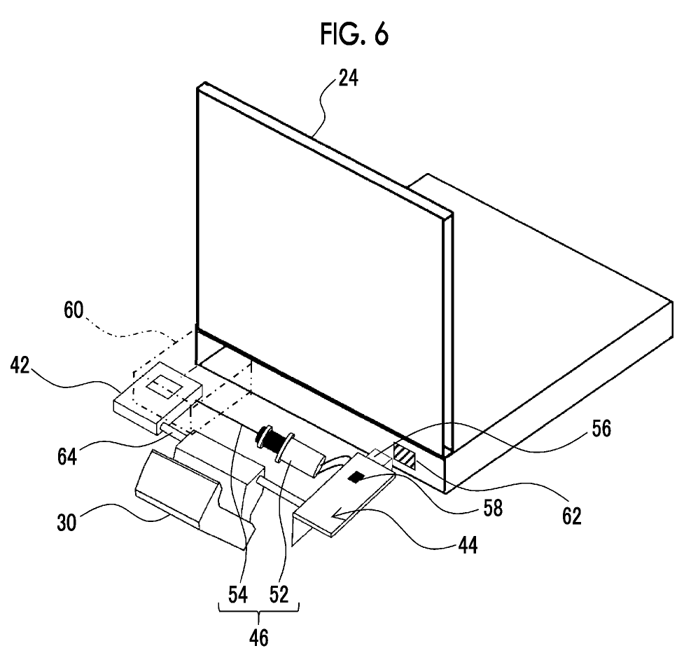

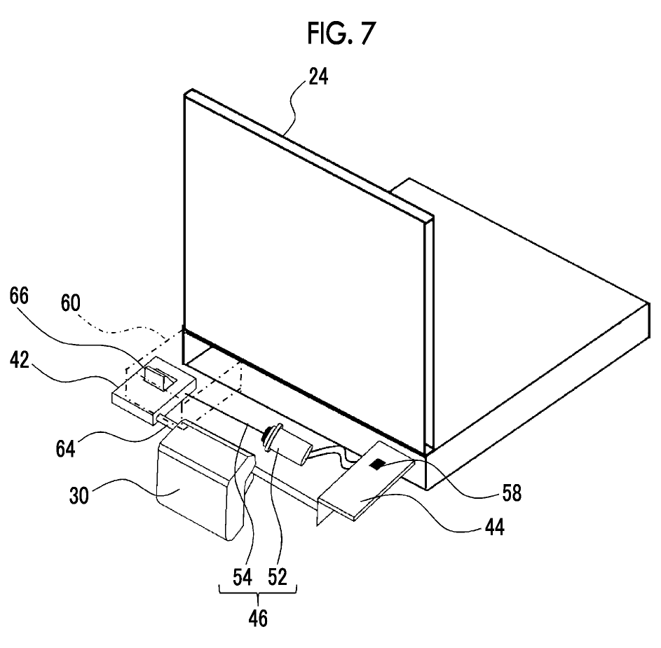

FIG. 6 schematically shows the states of the ultrasound diagnostic device 24, the catching mechanism 42, the drive mechanism 46, and the connection mechanism 44 in a case where the ultrasound diagnostic device 24 is placed on the table 16 and the operation lever 30 is in the non-restrained state. FIG. 7 schematically shows the states of the ultrasound diagnostic device 24, the catching mechanism 42, the drive mechanism 46, and the connection mechanism 44 in a case where the ultrasound diagnostic device 24 is placed on the table 16 and the operation lever 30 is in the restrained state. In order to make the structure easy to understand, a catching structure 60 formed at a left rear portion of the ultrasound diagnostic device 24 is schematically shown by a one-dot chain line in both of FIGS. 6 and 7.

As shown in FIG. 6, in a case where the operation lever 30 is in the non-restrained state, the connector 56 of the connection mechanism 44 is in a state of being pulled out from a receiving-side connector 62 of the ultrasound diagnostic device 24. As shown in FIG. 7, in a case where the operation lever 30 is in the restrained state, the rotational movement shaft 64 rotates, and the connection mechanism 44 moves forward. As a result, the connector 56 also moves forward, and the connector 56 is inserted into the receiving-side connector 62.

The connection mechanism 44 comprises a controller 58 that determines whether or not the ultrasound diagnostic device 24 and the hard disk drive 40 are electrically connected to each other and that controls the drive mechanism 46 in response to a determination result. The controller 58 may be configured by an electronic circuit including a semiconductor element. In this case, the determination and the control in response to the determination result include a state (a state of the electronic circuit or the like) in which the drive mechanism 46 is controlled by a condition of whether or not the ultrasound diagnostic device 24 and the hard disk drive 40 are electrically connected to each other. The controller 58 supplies power to the solenoid 52 provided in the drive mechanism 46 in a case where the ultrasound diagnostic device 24 and the hard disk drive 40 are electrically connected to each other. As a result, the drive shaft 54 provided in the drive mechanism 46 is in the pulled-out state.

The catching mechanism 42 comprises a claw 66 that moves up and down depending on a driving force transmitted from the drive shaft 54. The catching mechanism 42 is a mechanism that converts a lateral driving force into a vertical driving force. That is, the catching mechanism 42 converts the lateral driving force transmitted by the drive shaft 54 into the vertical driving force and transmits the vertical driving force to the claw 66.

In a case where the drive shaft 54 is in the pulled-out state, the claw 66 of the catching mechanism 42 protrudes upward. The claw 66 is caught by the catching structure 60 in the ultrasound diagnostic device 24. As a result, the ultrasound diagnostic device 24 is in a state where it is not detached from the table 16.

The controller 58 cuts off the power supplied to the solenoid 52 provided in the drive mechanism 46 in a case where the ultrasound diagnostic device 24 and the hard disk drive 40 are not electrically connected to each other. As a result, the drive shaft 54 is in the accommodated state. In a case where the drive shaft 54 is in the accommodated state, the claw 66 of the catching mechanism 42 is pulled down. The claw 66 is separated from the catching structure 60 in the ultrasound diagnostic device 24. As a result, the ultrasound diagnostic device 24 is in a state of being attachable to and detachable from the table 16.

With such a configuration, in the ultrasound diagnostic apparatus 100, the following processing is executed together with the attachment and detachment operation of the ultrasound diagnostic device 24 to the table 16. In a case where the operation lever 30 is in the non-restrained state, the user places the ultrasound diagnostic device 24 on the table 16 and sets the operation lever 30 to the restrained state. As a result, the connector 56 in the connection mechanism 44 is inserted into the receiving-side connector 62 of the ultrasound diagnostic device 24, and the ultrasound diagnostic device 24 and the hard disk drive 40 are electrically connected to each other. The controller 58 in the connection mechanism 44 supplies power to the solenoid 52 of the drive mechanism 46 based on the determination that the ultrasound diagnostic device 24 and the hard disk drive 40 are electrically connected to each other. As a result, the drive shaft 54 is in the pulled-out state from the accommodated state, the claw 66 of the catching mechanism 42 protrudes upward, and the claw 66 is caught by the catching structure 60 of the ultrasound diagnostic device 24. As a result, the ultrasound diagnostic device 24 is in a state where it is not detached from the table 16.

The user sets the operation lever 30 from the restrained state to the non-restrained state, and the connector 56 in the connection mechanism 44 is pulled out from the receiving-side connector 62 of the ultrasound diagnostic device 24. As a result, the ultrasound diagnostic device 24 and the hard disk drive 40 are disconnected from each other. The controller 58 in the connection mechanism 44 cuts off the power supplied to the solenoid 52 of the drive mechanism 46 based on the determination that the ultrasound diagnostic device 24 and the hard disk drive 40 are not electrically connected to each other, that is, are disconnected from each other. As a result, the drive shaft 54 is in the accommodated state from the pulled-out state, the claw 66 of the catching mechanism 42 is pulled down, and the claw 66 is separated from the catching structure 60 in the ultrasound diagnostic device 24. As a result, the ultrasound diagnostic device 24 is in a state of being attachable to and detachable from the table 16.

According to the ultrasound diagnostic apparatus 100 according to the present embodiment, in a case where the ultrasound diagnostic device 24 is placed on the table 16 and the hard disk drive 40 is connected to the ultrasound diagnostic device 24, the claw 66 of the catching mechanism 42 is caught by the catching structure 60 of the ultrasound diagnostic device 24. As a result, in a case where data is written from the ultrasound diagnostic device 24 to the hard disk drive 40 or in a case where the ultrasound diagnostic device 24 reads data from the hard disk drive 40, the ultrasound diagnostic device 24 and the hard disk drive 40 are disconnected from each other, and the data being transmitted is prevented from being lost.

Here, as the engagement mechanism, the catching mechanism 42 using the claw 66 is shown. As the engagement mechanism, a mechanism may be used in which a hooked member or a rod-shaped member is caught on the catching structure 60 (engagement structure) in a case of engagement, and the catch of the hooked member or the rod-shaped member with the catching structure 60 is released in a case of release from the engagement.

The catching mechanism 42 may be disposed in a posture in which the claw 66 protrudes and is pulled in the vertical direction as described above, or may be disposed in a posture in which the claw 66 protrudes and is pulled in the lateral direction or the front-rear direction. The catching structure 60 is disposed in a posture in which the claw 66 is caught and the caught state is released in accordance with the movement direction of the claw 66.

In addition, in the above-described embodiment, the solenoid 52 is used in which the drive shaft 54 is in the pulled-out state in a case where the power is supplied and the drive shaft 54 is in the accommodated state in a case where the power is cut off. Instead of such a solenoid 52, a double solenoid including a first electromagnet that changes the drive shaft 54 from the accommodated state to the pulled-out state and a second electromagnet that changes the drive shaft 54 from the pulled-out state to the accommodated state may be provided. In the double solenoid, the drive shaft 54 is maintained in the pulled-out state by the power being supplied to the first electromagnet in a pulsed manner, and the drive shaft 54 is maintained in the accommodated state by the power being supplied to the second electromagnet in a pulsed manner. Here, the phrase "the power is supplied in a pulsed manner" means that a time waveform of the power rises and then falls within a certain time, thereby forming a pulse-shaped waveform.

What is claimed is:

1. An ultrasound diagnostic device support apparatus comprising:
a support structure that allows an ultrasound diagnostic device to be attached to and detached from the support structure;
a connection mechanism that is provided in the support structure and that electrically connects the ultrasound diagnostic device and an electronic device attached to the support structure, in a case where the ultrasound diagnostic device is coupled to the connection mechanism;
an operation mechanism that releases the coupling between the ultrasound diagnostic device and the connection mechanism in response to an operation of a user; and
an engagement mechanism that is in an engaged state in a case where the connection mechanism electrically connects the ultrasound diagnostic device and the electronic device, thereby engaging the support structure with the ultrasound diagnostic device, and that is in a released state in a case where the connection mechanism does not electrically connect the ultrasound diagnostic device and the electronic device, thereby releasing the ultrasound diagnostic device from the support structure.

2. The ultrasound diagnostic device support apparatus according to claim 1, further comprising:
a controller that is provided in the connection mechanism,
wherein the controller
determines whether or not the connection mechanism electrically connects the electronic device and the ultrasound diagnostic device,
sets the engagement mechanism to the engaged state in a case where it is determined that the connection mechanism electrically connects the ultrasound diagnostic device and the electronic device, and
sets the engagement mechanism to the released state in a case where it is determined that the connection mechanism does not electrically connect the ultrasound diagnostic device and the electronic device.

3. The ultrasound diagnostic device support apparatus according to claim 1, further comprising:
a drive mechanism that drives the engagement mechanism by electric power,
wherein the drive mechanism sets the engagement mechanism to the engaged state, depending on a state of power supply to the drive mechanism, in a case where the connection mechanism electrically connects the ultrasound diagnostic device and the electronic device, and
the drive mechanism sets the engagement mechanism to the released state, depending on the state of power supply to the drive mechanism, in a case where the connection mechanism does not electrically connect the ultrasound diagnostic device and the electronic device.

4. The ultrasound diagnostic device support apparatus according to claim 3,
wherein the drive mechanism includes
a drive shaft, and
a power drive mechanism that pulls out a part of the drive shaft depending on the state of power supply and that accommodates the part of the drive shaft depending on the state of power supply, and
the engagement mechanism further engages with the ultrasound diagnostic device by pulling out the part of the drive shaft from the drive mechanism and releases the engagement with the ultrasound diagnostic device by accommodating the part of the drive shaft in the drive mechanism.

5. The ultrasound diagnostic device support apparatus according to claim 1,
wherein the connection mechanism includes a connector, and
the operation mechanism attaches the connector to the ultrasound diagnostic device or detaches the connector from the ultrasound diagnostic device in response to the operation of the user.

6. The ultrasound diagnostic device support apparatus according to claim 1,
wherein the electronic device is a storage medium.

7. An ultrasound diagnostic apparatus comprising:
the ultrasound diagnostic device support apparatus according to claim 1; and
the ultrasound diagnostic device.
